(19) United States
(12) Patent Application Publication
(10) Pub. No.: US 2023/0389147 A1
(43) Pub. Date: Nov. 30, 2023

(54) LIGHTING APPARATUS

(71) Applicant: LEEDARSON LIGHTING CO.,LTD., Zhangzhou (CN)

(72) Inventors: Changjing Zeng, Zhangzhou (CN); Zongyuan Liu, Zhangzhou (CN); Qiqiang Lin, Zhangzhou (CN); Hao Chen, Zhangzhou (CN); Yankun Li, Zhangzhou (CN); Hemu Ye, Zhangzhou (CN); Liangliang Cao, Zhangzhou (CN)

(21) Appl. No.: 18/203,025

(22) Filed: May 29, 2023

(30) Foreign Application Priority Data
May 27, 2022 (CN) 202210596242.6

(51) Int. Cl. H05B 45/20

(52) U.S. Cl. CPC H05B 45/20

(57) ABSTRACT

A lighting apparatus includes a first LED module, a second LED module, a third LED module, and a driver. The first LED module emits a blue light with a first peak wavelength between 440-470 nm. The second LED module emits a green light with a second peak wavelength between 510-550 nm, a second spectral bandwidth larger than 50 nm and a second color purity larger than 50%. The third LED module emits a red light with a third peak wavelength between 600-650 nm, a third spectral bandwidth larger than 60 nm and a third color purity larger than 80%. The driver adjusts a light ratio among the first blue light, the green light and the red light.

### FIELD

The present invention is related to a lighting apparatus, and more particularly related to a lighting apparatus with a stable light quality during light adjustment.

### BACKGROUND

The time when the darkness is being lighten up by the light, human have noticed the need of lighting up this planet. Light has become one of the necessities we live with through the day and the night. During the darkness after sunset, there is no natural light, and human have been finding ways to light up the darkness with artificial light. From a torch, candles to the light we have nowadays, the use of light have been changed through decades and the development of lighting continues on.

Early human found the control of fire which is a turning point of the human history. Fire provides light to bright up the darkness that have allowed human activities to continue into the darker and colder hour of the hour after sunset. Fire gives human beings the first form of light and heat to cook food, make tools, have heat to live through cold winter and lighting to see in the dark.

Lighting is now not to be limited just for providing the light we need, but it is also for setting up the mood and atmosphere being created for an area. Proper lighting for an area needs a good combination of daylight conditions and artificial lights. There are many ways to improve lighting in a better cost and energy saving. LED lighting, a solid-state lamp that uses light-emitting diodes as the source of light, is a solution when it comes to energy-efficient lighting. LED lighting provides lower cost, energy saving and longer life span.

The major use of the light emitting diodes is for illumination. The light emitting diodes is recently used in light bulb, light strip or light tube for a longer lifetime and a lower energy consumption of the light. The light emitting diodes shows a new type of illumination which brings more convenience to our lives. Nowadays, light emitting diode light may be often seen in the market with various forms and affordable prices.

After the invention of LEDs, the neon indicator and incandescent lamps are gradually replaced. However, the cost of initial commercial LEDs was extremely high, making them rare to be applied for practical use. Also, LEDs only illuminated red light at early stage. The brightness of the light only could be used as indicator for it was too dark to illuminate an area. Unlike modern LEDs which are bound in transparent plastic cases, LEDs in early stage were packed in metal cases.

In 1878, Thomas Edison tried to make a usable light bulb after experimenting different materials. In November 1879, Edison filed a patent for an electric lamp with a carbon filament and keep testing to find the perfect filament for his light bulb. The highest melting point of any chemical element, tungsten, was known by Edison to be an excellent material for light bulb filaments, but the machinery needed to produce super-fine tungsten wire was not available in the late 19th century. Tungsten is still the primary material used in incandescent bulb filaments today.

Early candles were made in China in about 200 BC from whale fat and rice paper wick. They were made from other materials through time, like tallow, spermaceti, colza oil and beeswax until the discovery of paraffin wax which made production of candles cheap and affordable to everyone. Wick was also improved over time that made from paper, cotton, hemp and flax with different times and ways of burning. Although not a major light source now, candles are still here as decorative items and a light source in emergency situations. They are used for celebrations such as birthdays, religious rituals, for making atmosphere and as a decor.

Illumination has been improved throughout the times. Even now, the lighting device we used today are still being improved. From the illumination of the sun to the time when human can control fire for providing illumination which changed human history, we have been improving the lighting source for a better efficiency and sense. From the invention of candle, gas lamp, electric carbon arc lamp, kerosene lamp, light bulb, fluorescent lamp to LED lamp, the improvement of illumination shows the necessity of light in human lives.

There are various types of lighting apparatuses. When cost and light efficiency of LED have shown great effect compared with traditional lighting devices, people look for even better light output. It is important to recognize factors that can bring more satisfaction and light quality and flexibility.

There are various to generate mixed light in LED light device design.

When using two or more white light sources to mix a desired white light, the color temperature may be well controlled, but the color rendering index may fail to meet certain standard.

It is difficult but beneficial to find best parameter sets to fit human coloring sense. This is not only mathematics, but takes lots of efforts and experiments.

Not many engineers notice this technical problem yet. Therefore, it is beneficial to develop a light system meeting multiple requirements while keeping them simple and low-cost.

### SUMMARY

In some embodiments, a lighting apparatus includes a first LED module, a second LED module, a third LED module, and a driver.

The first LED module emits a blue light with a first peak wavelength between 440-470 nm.

The second LED module emits a green light with a second peak wavelength between 510-550 nm, a second spectral bandwidth larger than 50 nm and a second color purity larger than 50%.

The third LED module emits a red light with a third peak wavelength between 600-650 nm, a third spectral bandwidth larger than 60 nm and a third color purity larger than 80%.

The driver adjusts a light ratio among the first blue light, the green light and the red light.

In some embodiments, a mixed light of the first blue light, the green light and the red light is a white light a color rendering index not smaller than 80 and a color tolerance adjustment smaller than 7SDCM.

In some embodiments, the white light spectrum forms a first area in CIE space.

The first area has an overlapping area with a standard sRGB area.

The overlapping lapping area is larger than 0.75 times the standard sRGB area.

In some embodiments, the third peak spectrum of the third LED module is between 625-635 nm.

In some embodiments, the second peak wavelength of the second LED module is between 510-525 nm, a second spectral bandwidth larger than 70 nm and a second color purity larger than 60%.

In some embodiments, third peak wavelength of the third LED module is between 610-635 nm, a third spectral bandwidth larger than 80 nm and a third color purity larger than 80%.

In some embodiments, in a first mode, the driver adjusts the third LED module to take a third light energy ratio between 20% to 70%, the second LED module to take a second light energy between 28% to 55%, and the first LED module to take a first energy ratio between 1% to 29%.

The first energy ratio, the second energy ratio and the third energy ratio are respectively energy levels over a total energy level of the first LED module, the second LED module and the third LED module.

In some embodiments, the red light has the third peak wave length between 610-635 nm, the third spectral bandwidth larger than 60 nm, the third color purity larger than 80%.

The green light has the second peak wave length between 510-525 nm, the second spectral bandwidth larger than 70 nm, the second purity larger than 60%, the blue peak wave length between 440-470 nm.

In some embodiments, in a second mode, the driver adjusts the third LED module to take a third light energy ratio between 2% to 75%, the second LED module to take a second light energy between 22% to 70%, and the first LED module to take a first energy ratio between 1% to 36%.

The first energy ratio, the second energy ratio and the third energy ratio are respectively energy levels over a total energy level of the first LED module, the second LED module and the third LED module.

In some embodiments, the red light has the third peak wave length between 600-650 nm, the third spectral bandwidth larger than 60 nm, the third color purity larger than 80%.

The green light has the second peak wave length between 510-550 nm, the second spectral bandwidth larger than 50 nm, the second purity larger than 50%, the blue peak wave length between 440-470 nm.

In some embodiments, in a third mode, the driver adjusts the third LED module to take a third light energy ratio between 2% to 44%, the second LED module to take a second light energy between 45% to 70%, and the first LED module to take a first energy ratio between 1% to 36%.

The first energy ratio, the second energy ratio and the third energy ratio are respectively energy levels over a total energy level of the first LED module, the second LED module and the third LED module.

In some embodiments, the red light has the third peak wave length between 625-635 nm, the third spectral bandwidth less than 60 nm, the third color purity larger than 80%.

The green light has the second peak wave length between 530-550 nm, the second spectral bandwidth larger than 90 nm, the second purity larger than 60%, the blue peak wave length between 450-470 nm.

In some embodiments, in a third mode, the driver adjusts the third LED module to take a third light energy ratio between 6% to 60%, the second LED module to take a second light energy between 35% to 70%, and the first LED module to take a first energy ratio between 1% to 31%.

The first energy ratio, the second energy ratio and the third energy ratio are respectively energy levels over a total energy level of the first LED module, the second LED module and the third LED module.

In some embodiments, the red light has the third peak wave length between 620-650 nm, the third spectral bandwidth larger than 60 nm, the third color purity larger than 80%.

The green light has the second peak wave length between 510-550 nm, the second spectral bandwidth larger than 90 nm, the second purity larger than 60%, the blue peak wave length between 440-460 nm.

In some embodiments, in a third mode, the driver adjusts the third LED module to take a third light energy ratio between 10% to 57%, the second LED module to take a second light energy between 45% to 65%, and the first LED module to take a first energy ratio between 1% to 29%.

The first energy ratio, the second energy ratio and the third energy ratio are respectively energy levels over a total energy level of the first LED module, the second LED module and the third LED module.

In some embodiments, the red light has the third peak wave length between 625-635 nm, the third spectral bandwidth less than 60 nm, the third color purity larger than 80%.

The green light has the second peak wave length between 530-550 nm, the second spectral bandwidth larger than 90 nm, the second purity larger than 60%, the blue peak wave length between 450-470 nm.

In some embodiments, the driver sets energy ratio range limits respectively for the first LED module, the second LED module and the third LED module to keep a required color rendering index of the mixed light.

In some embodiments, two sets of the first LED module, the second LED module and the third LED module are disposed on a same light source plate.

The first LED modules of the two sets have different parameters.

The driver selects only one of the two sets of the first LED module, the second LED module and the third LED module to turn on for generating a mixed light of a required parameter while keeping the required color rendering index.

In some embodiments, a first set of the two sets has three first energy ratio ranges.

A second set of the two sets has three second energy ratio ranges.

The first energy ratio ranges and the second energy ratio ranges are partially overlapped to keep a required color rendering index range, if the driver determines that mixing the first set to achieve a required color temperature falls out of the first energy ratio ranges, the driver selects the second set to mix the desired color temperature.

In some embodiments, if the first set is less turned on than the second set, the driver turns on the first set when a predetermined condition is met.

### BRIEF DESCRIPTION OF DRAWINGS

FIG. 1 illustrates three patterns for arranging red, blue, and green LED modules.

FIG. 2 illustrates a relative energy ratio of three LED modules.

FIG. 3 illustrates a light spectrum diagram of a mixed light.

FIG. 4 illustrates a mixed white light spectrum diagram.

FIG. 5 illustrates a RGB spectrum diagram.

FIG. 6 illustrates a white light spectrum diagram.

FIG. 7 illustrates an ANSI standard target diagram.

FIG. 8 illustrates a mixed color diagram of a second embodiment.

FIG. 9 illustrates a RGB spectrum diagram in a third embodiment.

FIG. 10 illustrates a white light spectrum diagram of a third embodiment.

FIG. 11 illustrates a standard ANSI target diagram.

FIG. 12 illustrates a RGB spectrum diagram of a fourth embodiment.

FIG. 13 illustrates a white light spectrum diagram of a fourth embodiment.

FIG. 14 illustrates a standard ANSI target diagram.

FIG. 15 illustrates a RBG spectrum diagram.

FIG. 16 illustrates a white light spectrum diagram.

FIG. 17 illustrates a standard ANSI target diagram.

FIG. 18 illustrates a RGB spectrum diagram.

FIG. 19 illustrates a white light spectrum diagram of a sixth embodiment.

FIG. 20 illustrates a circuit diagram for controlling the LED modules.

FIG. 21 illustrates a RGB spectrum diagram of a seventh embodiment.

FIG. 22 illustrates a white light spectrum diagram.

FIG. 23 illustrates a standard ANSI target diagram.

FIG. 24 illustrates a mixed color diagram.

FIG. 25 illustrates a standard ANSI target diagram.

FIG. 26 illustrates a circuit diagram used to drive the lighting apparatus.

FIG. 27 illustrates a control circuit using I2C signal.

FIG. 28 illustrates a circuit example with multiple path control.

FIG. 29 illustrates a circuit example with a bus control.

FIG. 30 illustrates another lighting apparatus embodiment.

### DETAILED DESCRIPTION

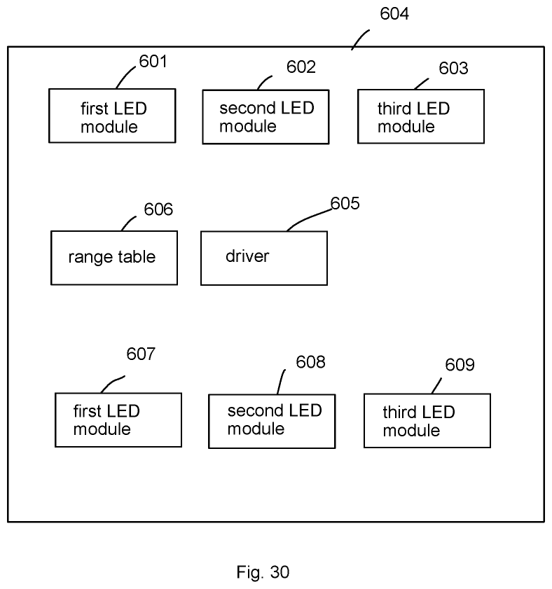

In FIG. 30, a lighting apparatus includes a first LED module 601, a second LED module 602, a third LED module 603, and a driver 605.

In this embodiment, there are two sets of LED modules. In addition to a first set of the first LED module 601, the second LED module 602, the third LED module 605, there is a second set of the first LED module 607, the second LED module 608 and the third LED module 609.

The first LED module 601 and the second LED module 607 both emit a blue light but with certain parameter difference.

The second LED module 602 and the second LED module 608 both emit a green light but with certain parameter difference.

The third LED module 603 and the third LED module 609 both emit a red light but with certain parameter difference.

The driver 605 receives an external command, e.g. from an external remote control or a mobile phone to instruct the driver 605 to change a mixed light by the LED modules on the light source plate 604.

Under lots of experiments and detail study, some rules are concluded to achieve a nice optical effect, i.e. to maintain color adjusting, color temperature adjustment, while keeping a high color rendering index.

The adjustment of color or color temperature mixing or light intensity adjusting requires the driver 605 to change driving currents supplied to the LED modules.

It is found that certain combination, e.g. the first set of LED modules, may have some energy ratio range limits to keep a required quality of color rendering index. If the first set cannot meet the required quality, the first set of LED modules are turned off by the driver 605 and the second set of LED modules are turned on and corresponding energy ratios of the first LED module 607, the second LED module 608 and the third LED module 609 are adjusted by the driver 605 to mix a required color, a required color temperature and/or a required light intensity.

The energy ratio means driving current ratios among the first LED module, the second LED module and the third LED module, respectively corresponding to blue light, green light and red light. For example, to mix a required color temperature, the first LED module, the second LED module and the third LED module may have corresponding driving ratios as 20%, 30%, 50%.

If such energy ratios still fall in energy ratio ranges stored in the range table 606, the driver 605 just use the LED modules to mix a required parameter.

However, if such energy ratios fall outside the energy ratio ranges stored in the range table 606, the driver 605 turns off the first set of LED modules and turn on the second LED modules that mix the required color temperature but still fall in an energy ratio ranges that guarantee an acceptable color rendering index, which is an important feature to ensure objects, like diamonds or paintings to look great under the illumination.

In the market, manufacturers may find LED modules that emit red light, green light and blue light of different parameter. In the invention, some parameters are particularly picked to find corresponding energy ratio ranges to ensure a required light quality like color rendering index.

In the following, there are several sets of experiment values found to achieve great illumination effect.

The first LED module emits a blue light with a first peak wavelength between 440-470 nm.

The second LED module emits a green light with a second peak wavelength between 510-550 nm, a second spectral bandwidth larger than 50 nm and a second color purity larger than 50%.

The third LED module emits a red light with a third peak wavelength between 600-650 nm, a third spectral bandwidth larger than 60 nm and a third color purity larger than 80%.

The driver adjusts a light ratio among the first blue light, the green light and the red light.

In some embodiments, a mixed light of the first blue light, the green light and the red light is a white light a color rendering index not smaller than 80 and a color tolerance adjustment smaller than 7SDCM.

In some embodiments, the white light spectrum forms a first area in CIE space.

The first area has an overlapping area with a standard sRGB area.

The overlapping lapping area is larger than 0.75 times the standard sRGB area.

In some embodiments, the third peak spectrum of the third LED module is between 625-635 nm.

In some embodiments, the second peak wavelength of the second LED module is between 510-525 nm, a second spectral bandwidth larger than 70 nm and a second color purity larger than 60%.

In some embodiments, third peak wavelength of the third LED module is between 610-635 nm, a third spectral bandwidth larger than 80 nm and a third color purity larger than 80%.

In some embodiments, in a first mode, the driver adjusts the third LED module to take a third light energy ratio between 20% to 70%, the second LED module to take a second light energy between 28% to 55%, and the first LED module to take a first energy ratio between 1% to 29%.

The first energy ratio, the second energy ratio and the third energy ratio are respectively energy levels over a total energy level of the first LED module, the second LED module and the third LED module.

In some embodiments, the red light has the third peak wave length between 610-635 nm, the third spectral bandwidth larger than 60 nm, the third color purity larger than 80%.

The green light has the second peak wave length between 510-525 nm, the second spectral bandwidth larger than 70 nm, the second purity larger than 60%, the blue peak wave length between 440-470 nm.

In some embodiments, in a second mode, the driver adjusts the third LED module to take a third light energy ratio between 2% to 75%, the second LED module to take a second light energy between 22% to 70%, and the first LED module to take a first energy ratio between 1% to 36%.

The first energy ratio, the second energy ratio and the third energy ratio are respectively energy levels over a total energy level of the first LED module, the second LED module and the third LED module.

In some embodiments, the red light has the third peak wave length between 600-650 nm, the third spectral bandwidth larger than 60 nm, the third color purity larger than 80%.

The green light has the second peak wave length between 510-550 nm, the second spectral bandwidth larger than 50 nm, the second purity larger than 50%, the blue peak wave length between 440-470 nm.

In some embodiments, in a third mode, the driver adjusts the third LED module to take a third light energy ratio between 2% to 44%, the second LED module to take a second light energy between 45% to 70%, and the first LED module to take a first energy ratio between 1% to 36%.

The first energy ratio, the second energy ratio and the third energy ratio are respectively energy levels over a total energy level of the first LED module, the second LED module and the third LED module.

In some embodiments, the red light has the third peak wave length between 625-635 nm, the third spectral bandwidth less than 60 nm, the third color purity larger than 80%.

The green light has the second peak wave length between 530-550 nm, the second spectral bandwidth larger than 90 nm, the second purity larger than 60%, the blue peak wave length between 450-470 nm.

In some embodiments, in a third mode, the driver adjusts the third LED module to take a third light energy ratio between 6% to 60%, the second LED module to take a second light energy between 35% to 70%, and the first LED module to take a first energy ratio between 1% to 31%.

The first energy ratio, the second energy ratio and the third energy ratio are respectively energy levels over a total energy level of the first LED module, the second LED module and the third LED module.

In some embodiments, the red light has the third peak wave length between 620-650 nm, the third spectral bandwidth larger than 60 nm, the third color purity larger than 80%.

The green light has the second peak wave length between 510-550 nm, the second spectral bandwidth larger than 90 nm, the second purity larger than 60%, the blue peak wave length between 440-460 nm.

In some embodiments, in a third mode, the driver adjusts the third LED module to take a third light energy ratio between 10% to 57%, the second LED module to take a second light energy between 45% to 65%, and the first LED module to take a first energy ratio between 1% to 29%.

The first energy ratio, the second energy ratio and the third energy ratio are respectively energy levels over a total energy level of the first LED module, the second LED module and the third LED module.

In some embodiments, the red light has the third peak wave length between 625-635 nm, the third spectral bandwidth less than 60 nm, the third color purity larger than 80%.

The green light has the second peak wave length between 530-550 nm, the second spectral bandwidth larger than 90 nm, the second purity larger than 60%, the blue peak wave length between 450-470 nm.

In some embodiments, the driver sets energy ratio range limits respectively for the first LED module, the second LED module and the third LED module to keep a required color rendering index of the mixed light.

In some embodiments, two sets of the first LED module, the second LED module and the third LED module are disposed on a same light source plate.

The first LED modules of the two sets have different parameters.

The driver selects only one of the two sets of the first LED module, the second LED module and the third LED module to turn on for generating a mixed light of a required parameter while keeping the required color rendering index.

In some embodiments, a first set of the two sets has three first energy ratio ranges.

A second set of the two sets has three second energy ratio ranges.

The first energy ratio ranges and the second energy ratio ranges are partially overlapped to keep a required color rendering index range, if the driver determines that mixing the first set to achieve a required color temperature falls out of the first energy ratio ranges, the driver selects the second set to mix the desired color temperature.

In some embodiments, if the first set is less turned on than the second set, the driver turns on the first set when a predetermined condition is met.

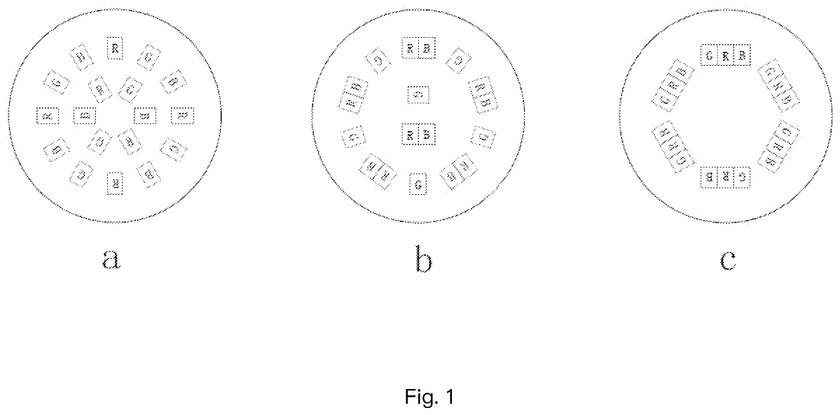

Please refer to FIG. 1.

In FIG. 1, three patterns a, b, c respectively show three examples of arrangement of multiple R, G, B LED modules for emitting red light, green light and blue light.

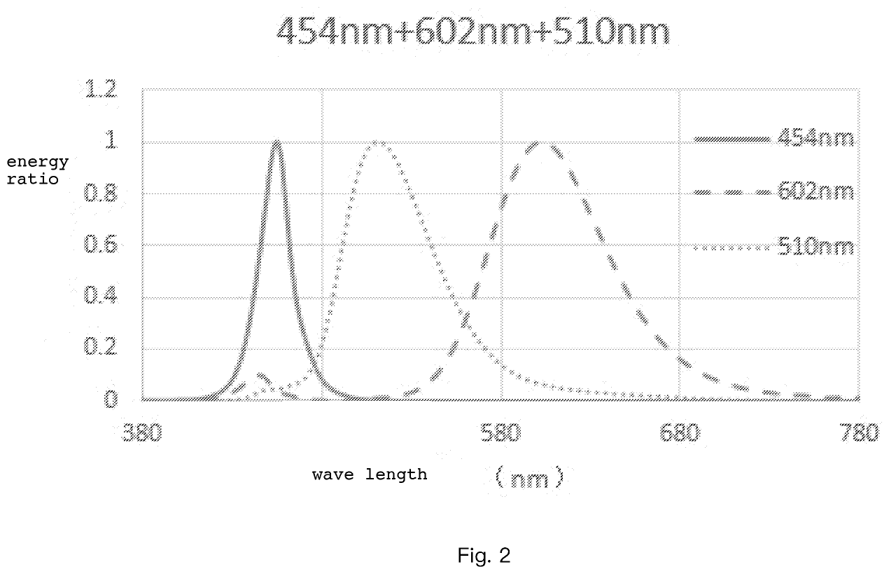

FIG. 2 show energy ratio for three LED modules respectively.

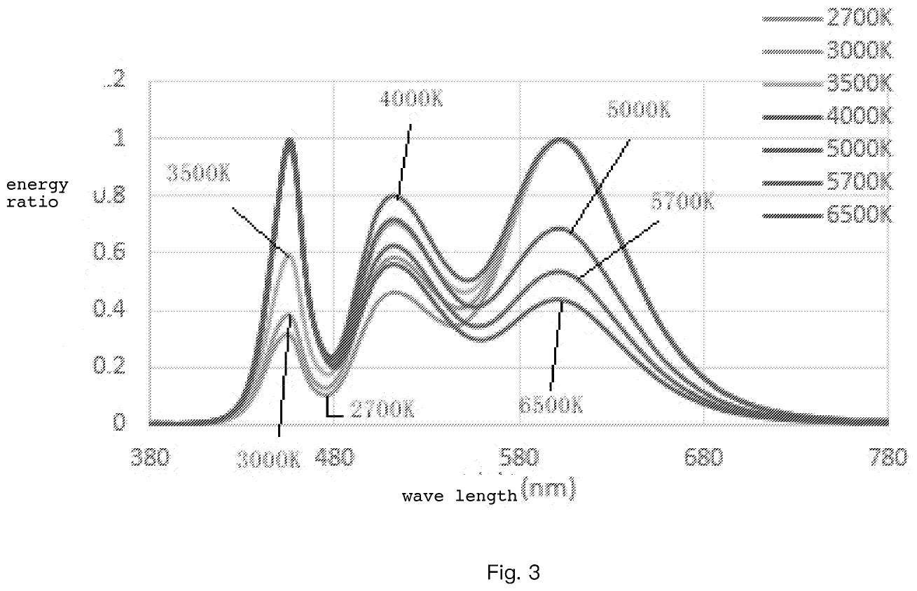

FIG. 3 shows color temperature adjustment by mixing three LED modules.

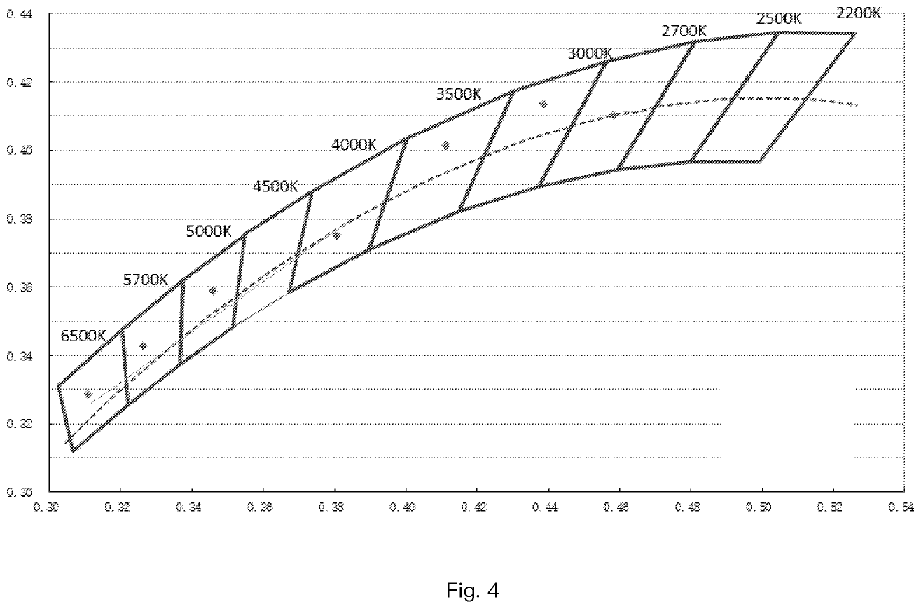

FIG. 4 shows that by controlling energy ratio ranges, a required light parameter is ensured to fall in a desired range.

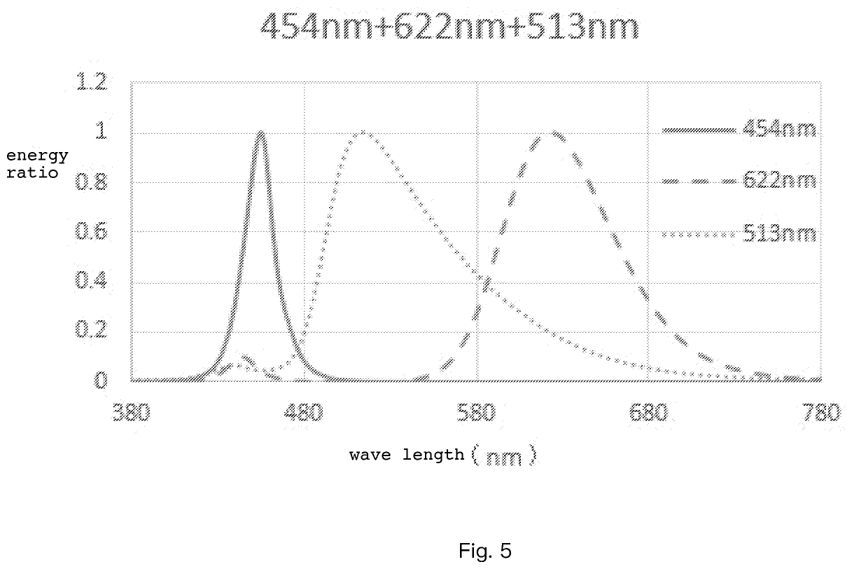

FIG. 5 shows another set of LED modules with different parameters.

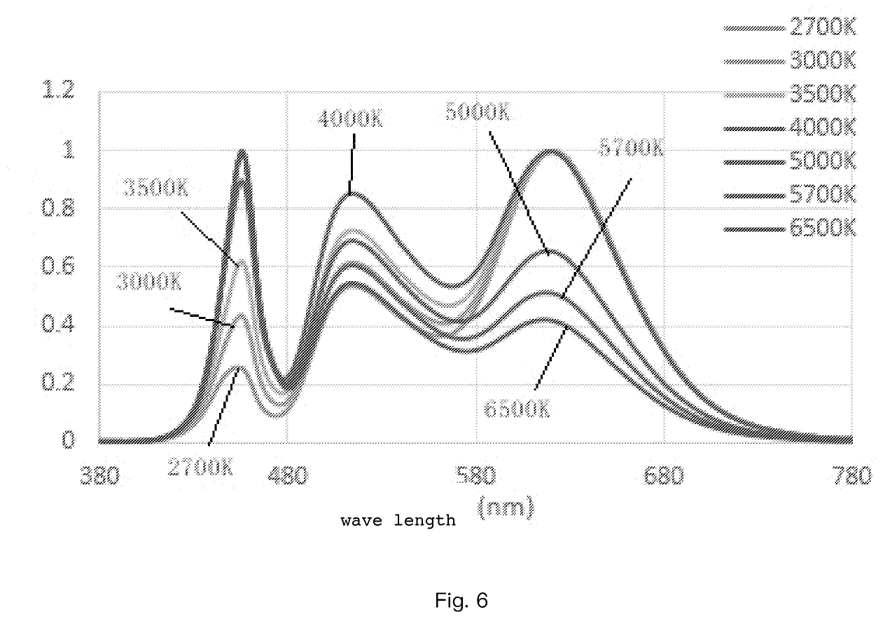

FIG. 6 shows another embodiment with different color temperature adjustment by using different sets of LED modules.

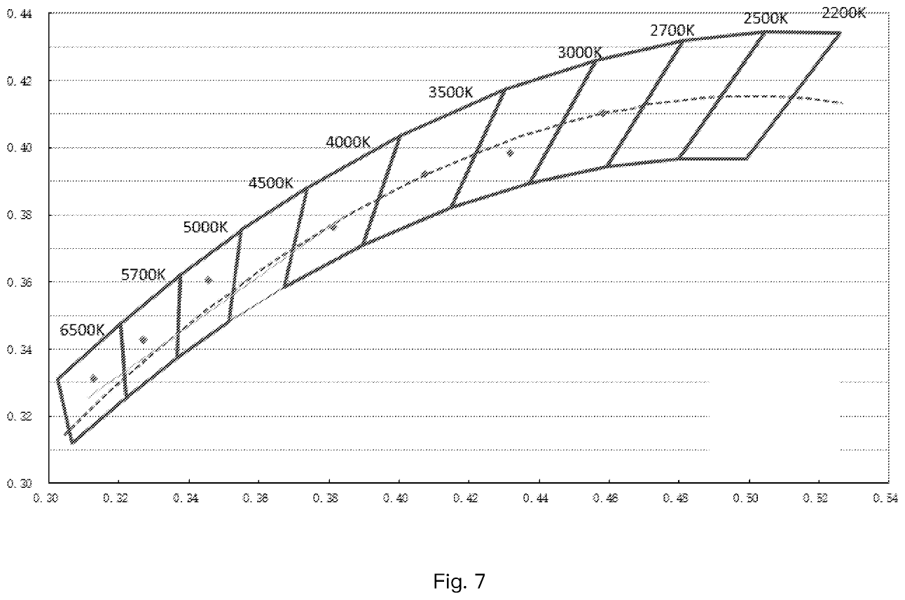

FIG. 7 shows that a different mixed light quality which still fall within a certain range of light quality.

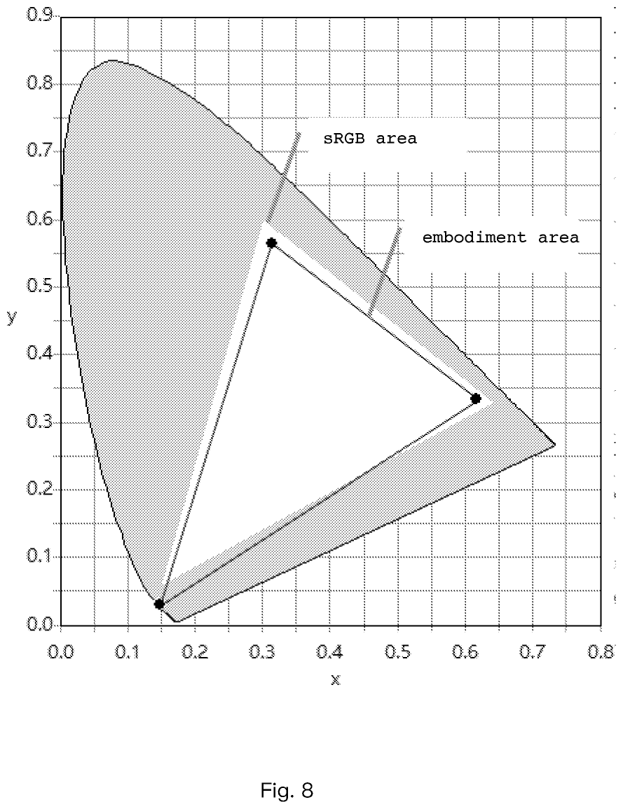

FIG. 8 shows that there is an overlapping area between sRGB area and the mixed embodiment range, which fall within the range ratio mentioned above on CSIE diagram.

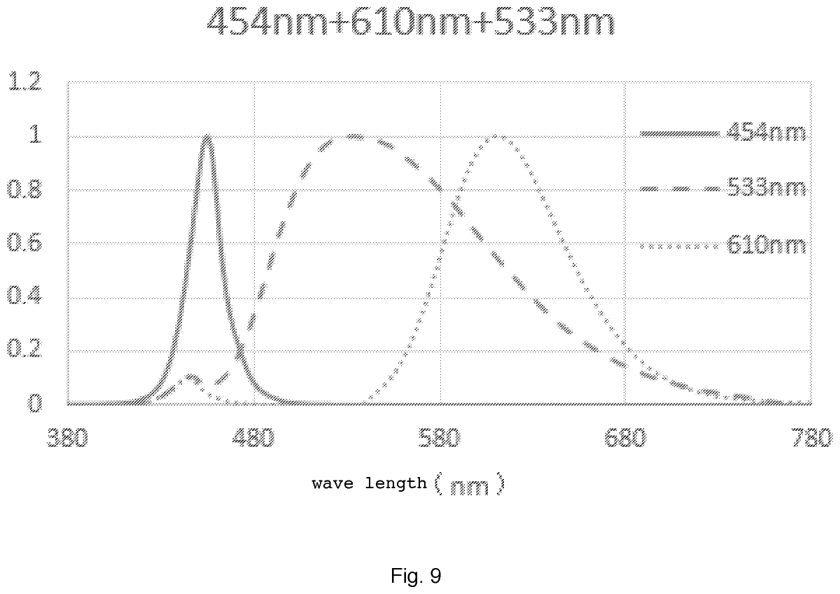

FIG. 9 shows another embodiment with different parameters and energy ratios.

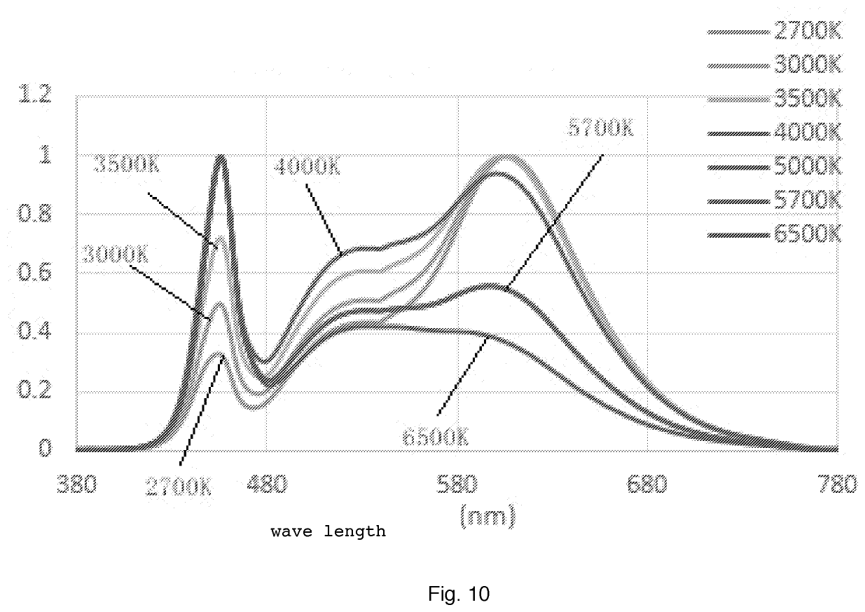

FIG. 10 shows another color temperature mixing with respect to energy ratio variation.

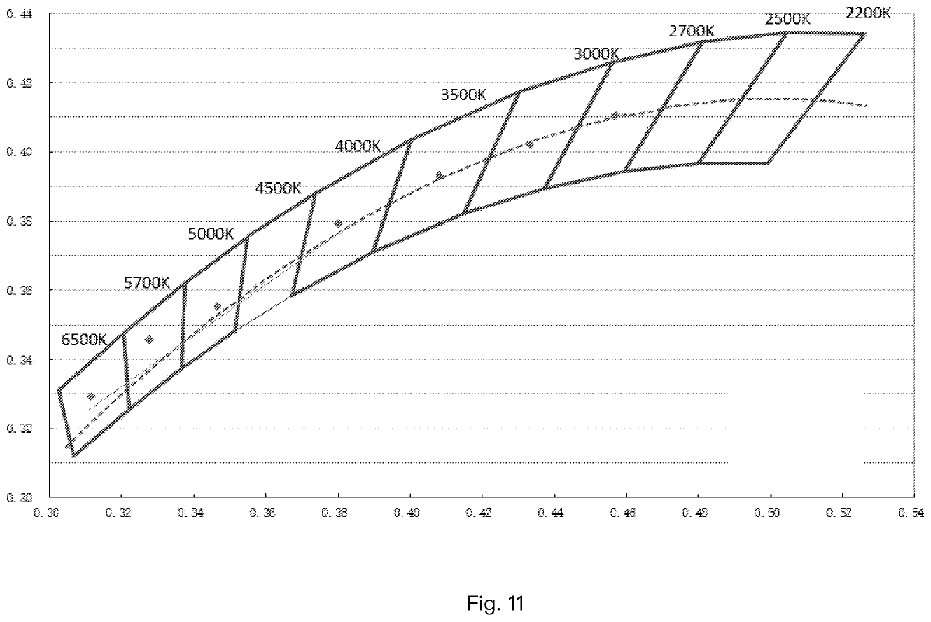

FIG. 11 shows a mixed light quality that falls more close to the desired curve line.

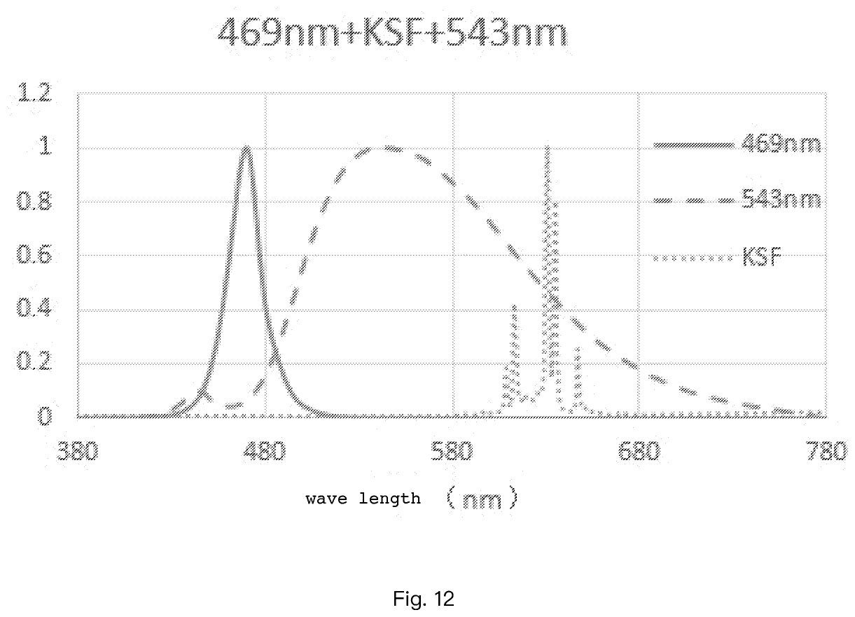

FIG. 12 shows another set of LED modules with different parameter and corresponding energy ratios.

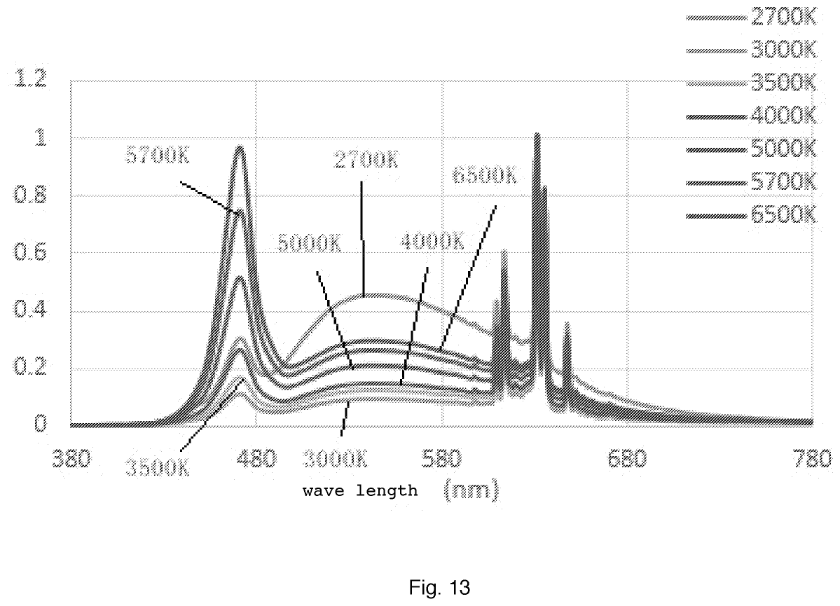

FIG. 13 shows another embodiment illustrating color temperature variations by mixing multiple LED modules.

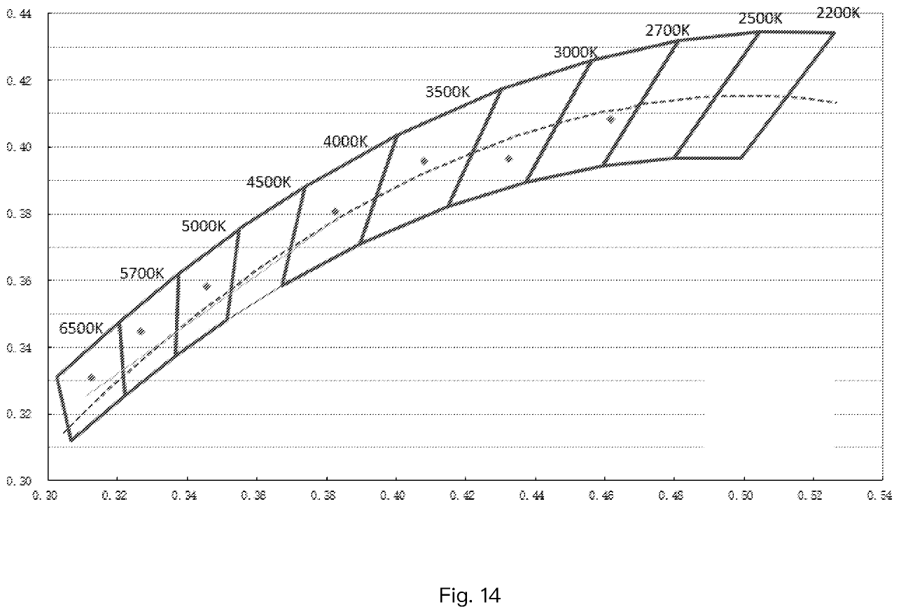

FIG. 14 shows another experiment for the deviation of mixed light quality during color temperature variation.

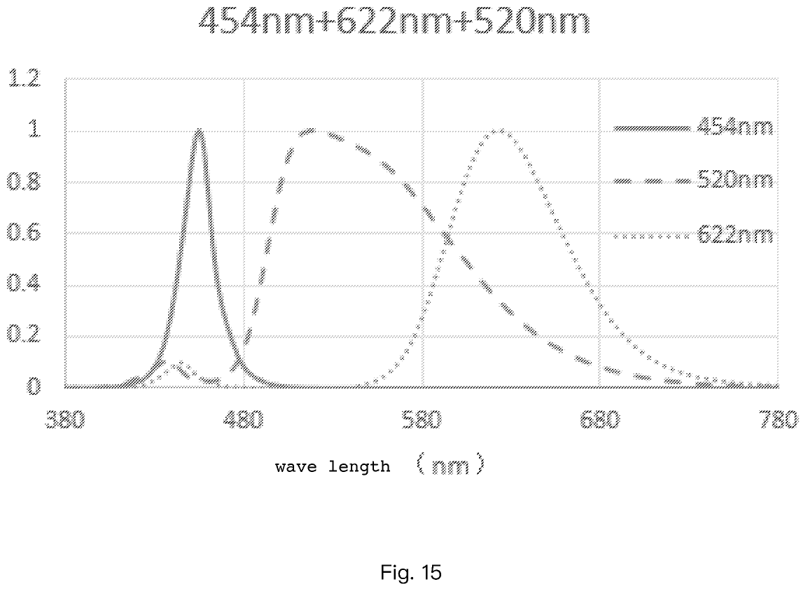

FIG. 15 shows another set of LED modules and their energy ratio.

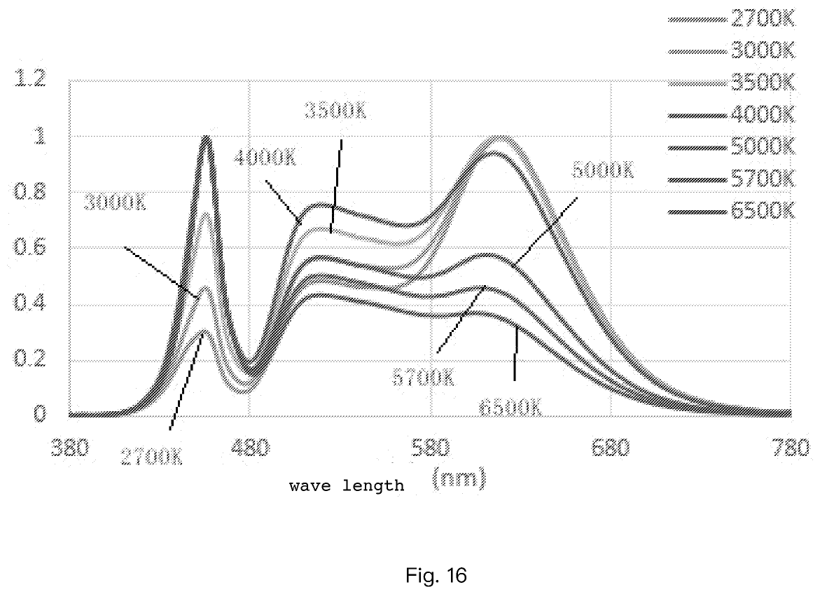

FIG. 16 shows another mixed light parameter variations.

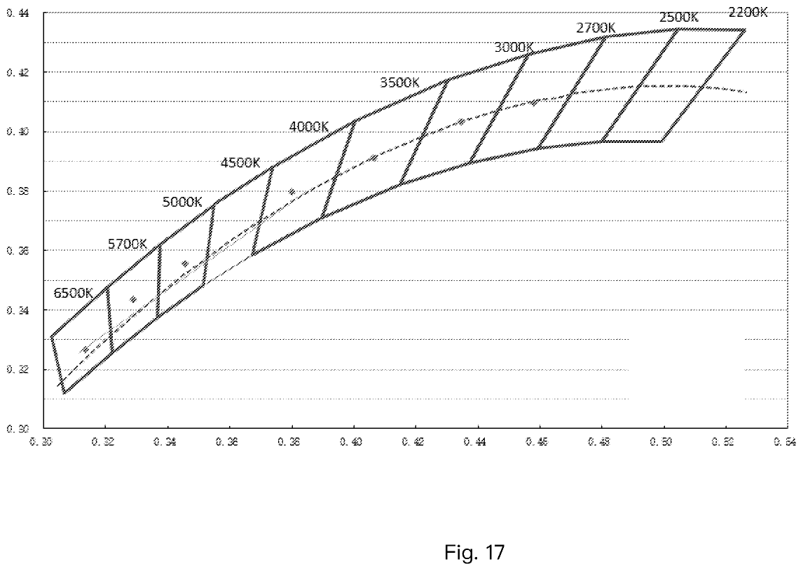

FIG. 17 shows another mixed light quality deviation.

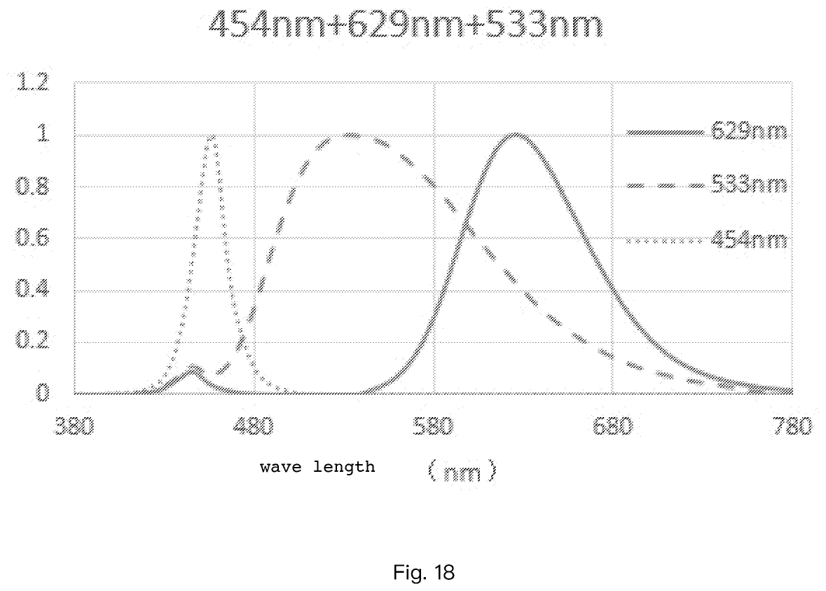

FIG. 18 shows another LED modules with different energy ratio.

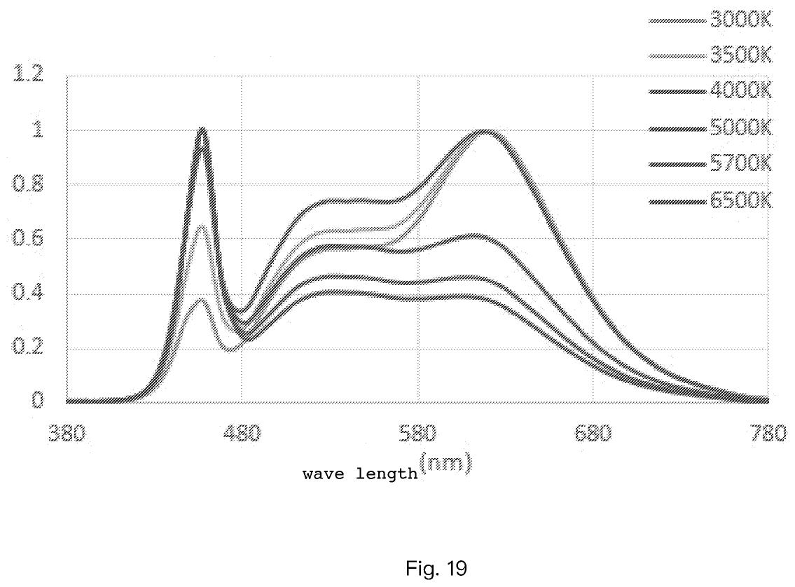

FIG. 19 shows another variation diagram.

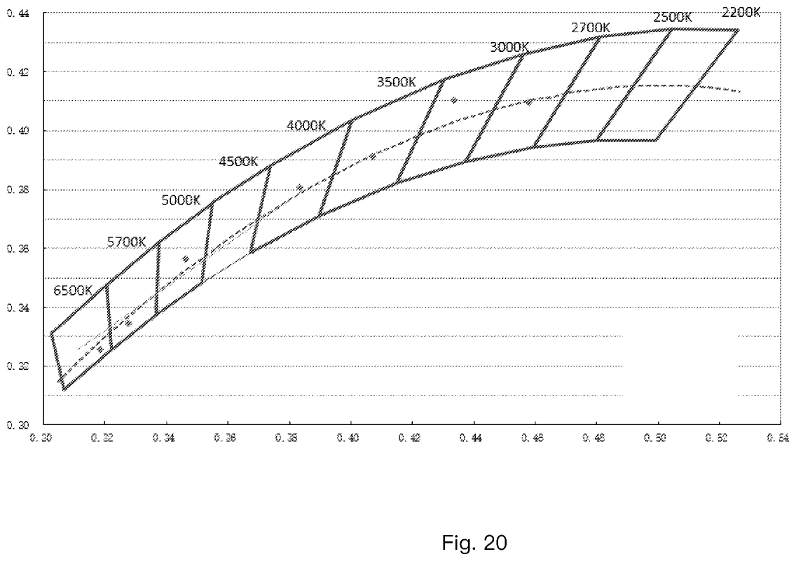

FIG. 20 shows another deviation light quality over different color temperature variation.

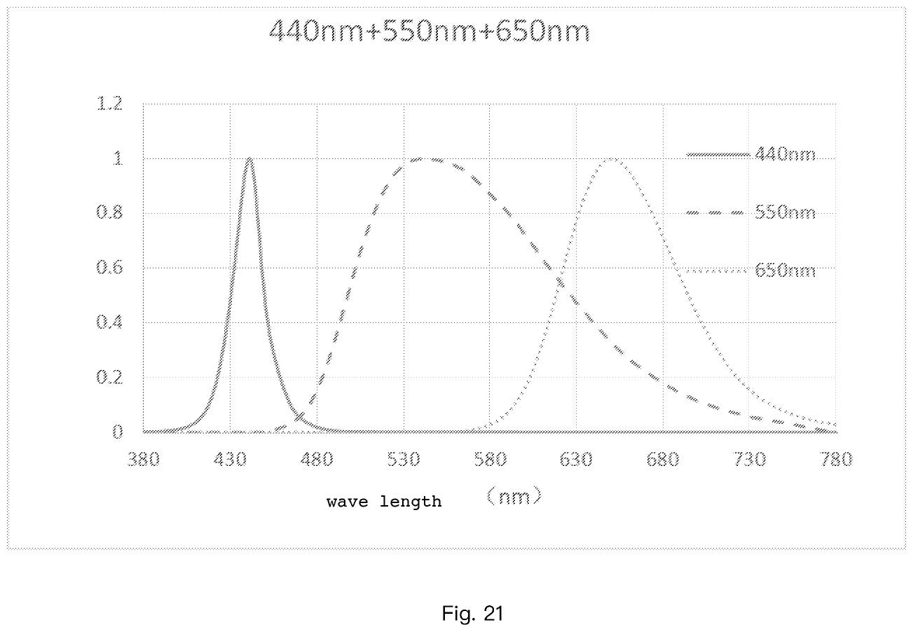

FIG. 21 shows another experiment with different LED modules and energy ratio.

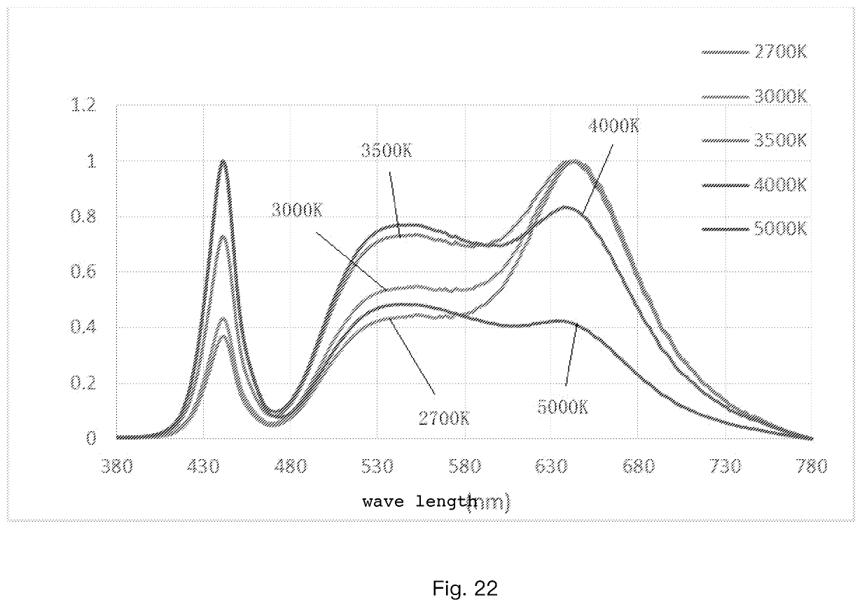

FIG. 22 shows another experiment with different color temperature variation.

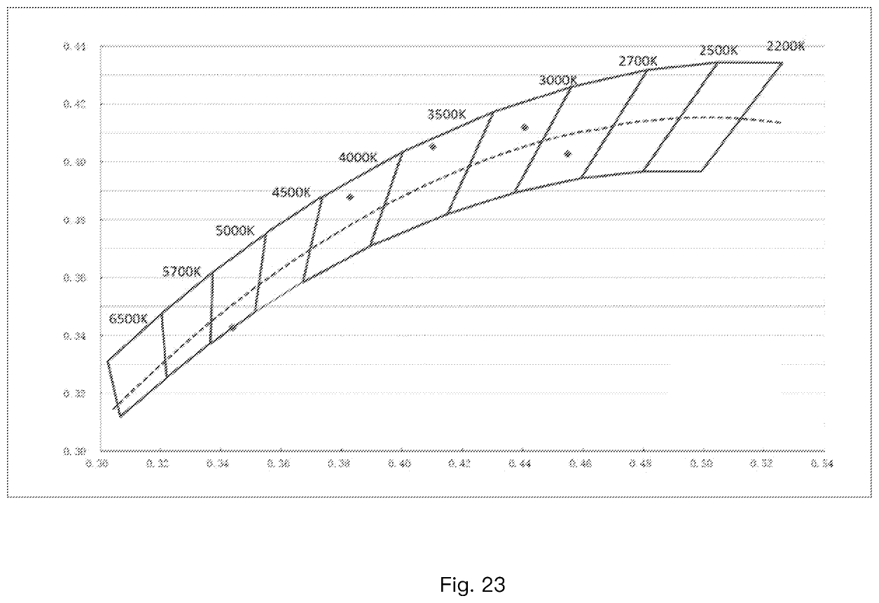

FIG. 23 shows a deviation result under different parameter configuration.

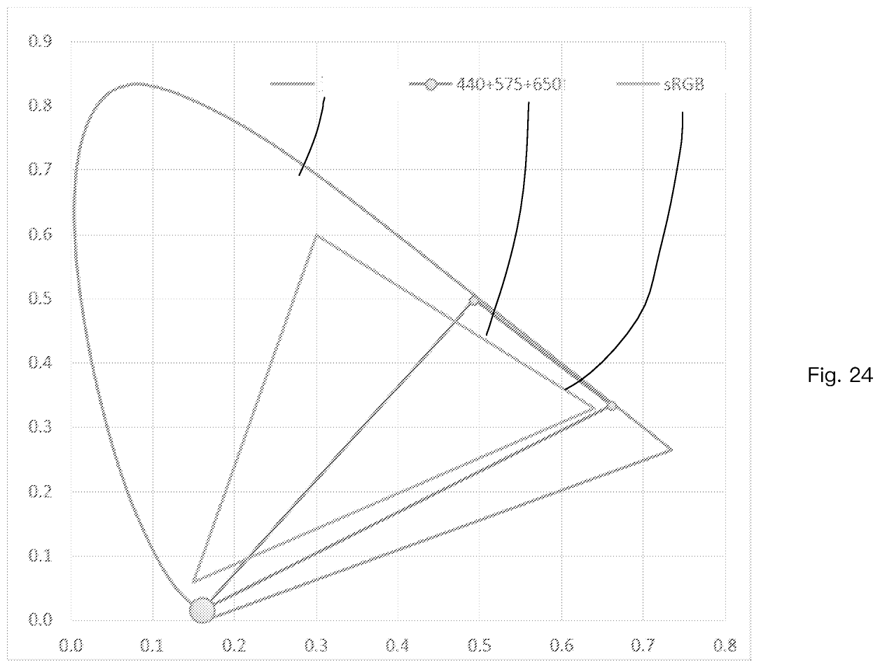

FIG. 24 shows that the mixed color spectrum area of 440+575+650 LED modules compared with sRGB and standard spectrum of color.

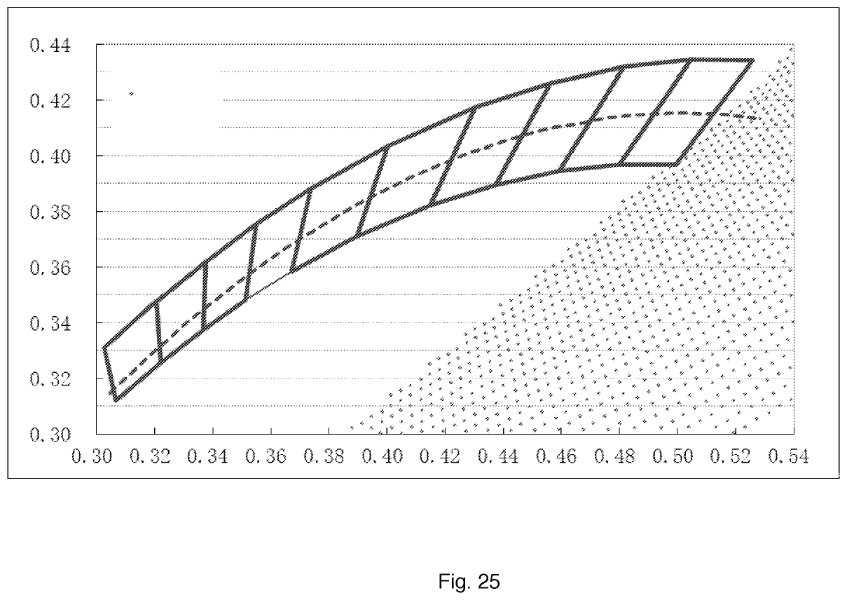

FIG. 25 shows an experiment result for approaching desired light quality by limiting energy ratio ranges.

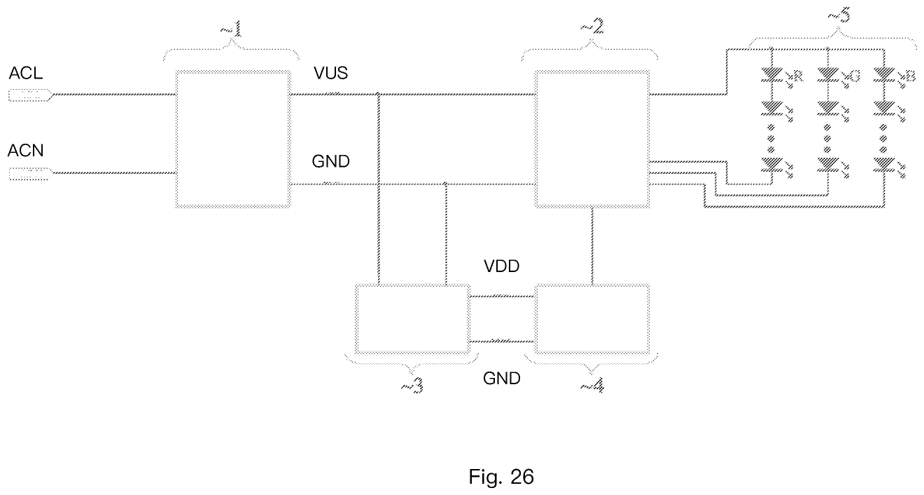

FIG. 26 shows a circuit diagram. In FIG. 26, the rectifier 1 converts AC current to DC current. The constant current source 2 receives a control signal from a control module 4. To ensure the quality of current, there is a power supply 3 for generating power to the control module 4. The light source 5 include LED modules for emitting red, blue and green lights.

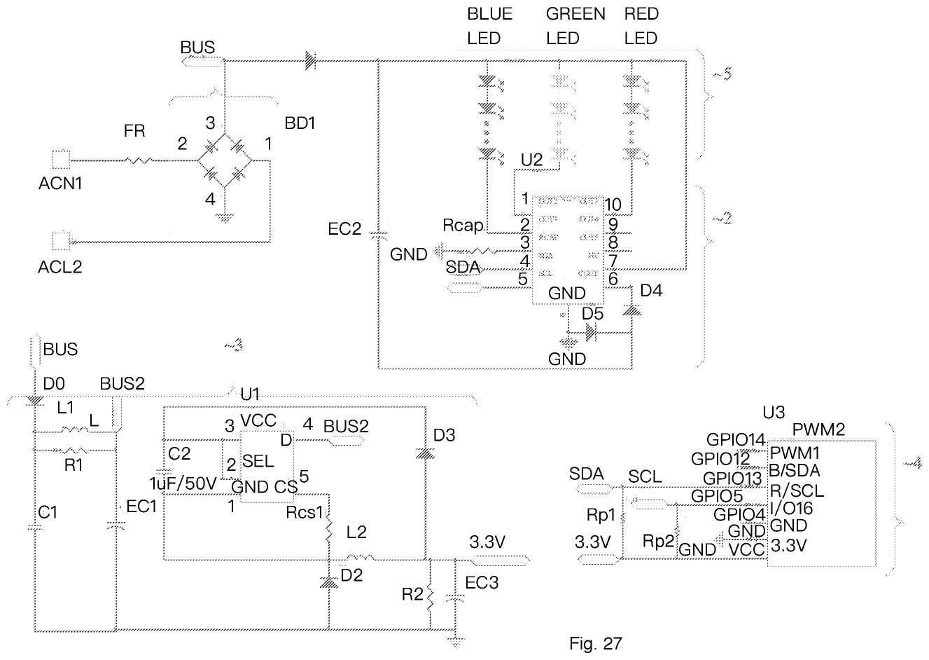

FIG. 27 shows a detailed example of the constant current source 5, the rectifier 1, the power supply 3, and the control module 4.

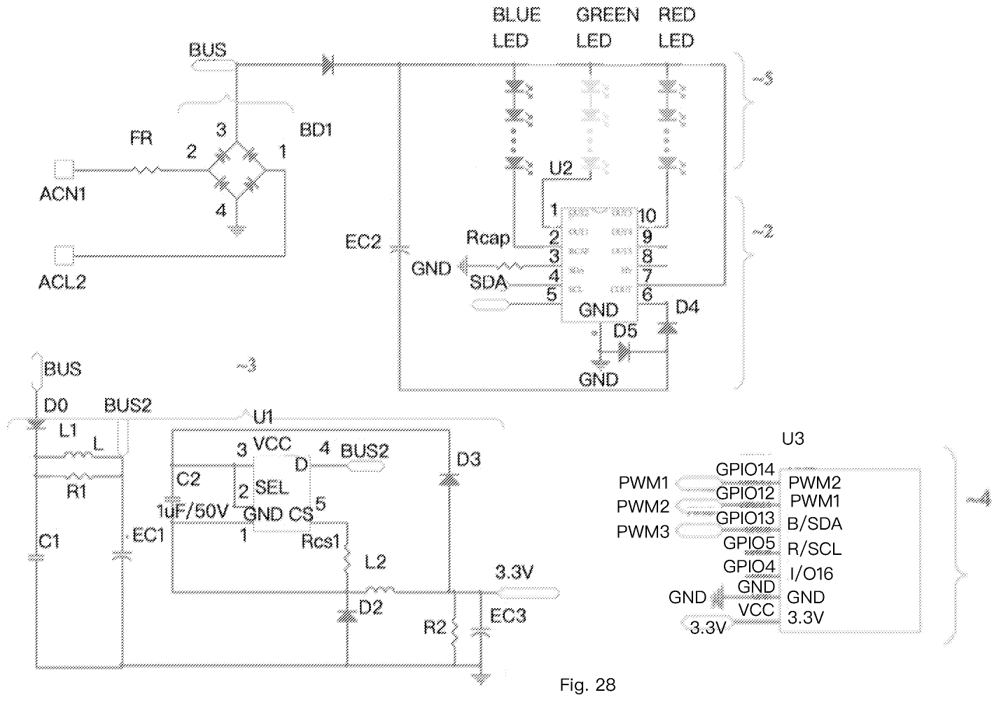

FIG. 28 shows a different circuit example of the embodiment in FIG. 26.

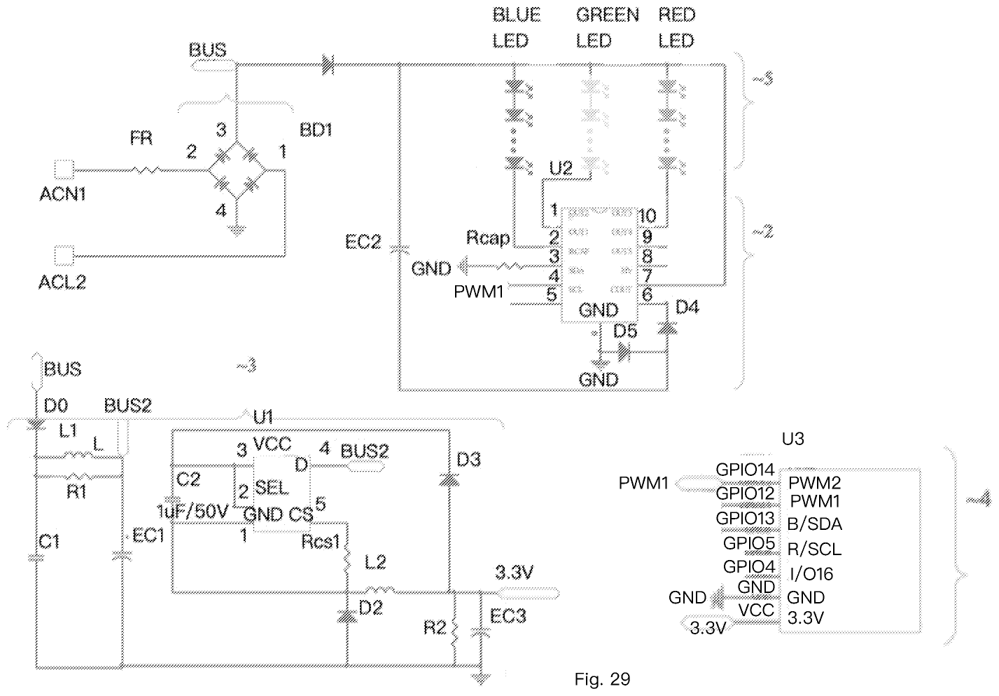

FIG. 29 shows another circuit example to implement the embodiment in FIG. 26.

In other words, I2C or bus control can be used for different requirements. In addition, PWM or other driving currents may be used, too.

The major features by controlling energy ratio ranges to ensure light quality may be implemented with various known methods.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings.

The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

1. A lighting apparatus, comprising:
a first LED module for emitting a blue light with a first peak wavelength between 440-470 nm;
a second LED module for emitting a green light with a second peak wavelength between 510-550 nm, a second spectral bandwidth larger than 50 nm and a second color purity larger than 50%;
a third LED module for emitting a red light with a third peak wavelength between 600-650 nm, a third spectral bandwidth larger than 60 nm and a third color purity larger than 80%; and
a driver for adjusting a light ratio among the first blue light, the green light and the red light.

2. The lighting apparatus of claim 1, wherein a mixed light of the first blue light, the green light and the red light is a white light a color rendering index not smaller than 80 and a color tolerance adjustment smaller than 7SDCM.

3. The lighting apparatus of claim 2, wherein the white light spectrum forms a first area in CIE space, wherein the first area has an overlapping area with a standard sRGB area, wherein the overlapping lapping area is larger than 0.75 times the standard sRGB area.

4. The lighting apparatus of claim 1, wherein the third peak spectrum of the third LED module is between 625-635 nm.

5. The lighting apparatus of claim 1, wherein the second peak wavelength of the second LED module is between 510-525 nm, a second spectral bandwidth larger than 70 nm and a second color purity larger than 60%;

6. The lighting apparatus of claim 5, wherein third peak wavelength of the third LED module is between 610-635 nm, a third spectral bandwidth larger than 80 nm and a third color purity larger than 80%; and

7. The lighting apparatus of claim 1, wherein in a first mode, the driver adjusts the third LED module to take a third light energy ratio between 20% to 70%, the second LED module to take a second light energy between 28% to 55%, and the first LED module to take a first energy ratio between 1% to 29%, wherein the first energy ratio, the second energy ratio and the third energy ratio are respectively energy levels over a total energy level of the first LED module, the second LED module and the third LED module.

8. The lighting apparatus of claim 7, wherein the red light has the third peak wave length between 610-635 nm, the third spectral bandwidth larger than 60 nm, the third color purity larger than 80%, wherein the green light has the second peak wave length between 510-525 nm, the second spectral bandwidth larger than 70 nm, the second purity larger than 60%, the blue peak wave length between 440-470 nm.

9. The lighting apparatus of claim 1, wherein in a second mode, the driver adjusts the third LED module to take a third light energy ratio between 2% to 75%, the second LED module to take a second light energy between 22% to 70%, and the first LED module to take a first energy ratio between 1% to 36%, wherein the first energy ratio, the second energy ratio and the third energy ratio are respectively energy levels over a total energy level of the first LED module, the second LED module and the third LED module.

10. The lighting apparatus of claim 9, wherein the red light has the third peak wave length between 600-650 nm, the third spectral bandwidth larger than 60 nm, the third color purity larger than 80%, wherein the green light has the second peak wave length between 510-550 nm, the second spectral bandwidth larger than 50 nm, the second purity larger than 50%, the blue peak wave length between 440-470 nm.

11. The lighting apparatus of claim 1, wherein in a third mode, the driver adjusts the third LED module to take a third light energy ratio between 2% to 44%, the second LED module to take a second light energy between 45% to 70%, and the first LED module to take a first energy ratio between 1% to 36%, wherein the first energy ratio, the second energy ratio and the third energy ratio are respectively energy levels over a total energy level of the first LED module, the second LED module and the third LED module.

12. The lighting apparatus of claim 11, wherein the red light has the third peak wave length between 625-635 nm, the third spectral bandwidth less than 60 nm, the third color purity larger than 80%, wherein the green light has the second peak wave length between 530-550 nm, the second spectral bandwidth larger than 90 nm, the second purity larger than 60%, the blue peak wave length between 450-470 nm.

13. The lighting apparatus of claim 1, wherein in a third mode, the driver adjusts the third LED module to take a third light energy ratio between 6% to 60%, the second LED module to take a second light energy between 35% to 70%, and the first LED module to take a first energy ratio between 1% to 31%, wherein the first energy ratio, the second energy ratio and the third energy ratio are respectively energy levels over a total energy level of the first LED module, the second LED module and the third LED module.

14. The lighting apparatus of claim 13, wherein the red light has the third peak wave length between 620-650 nm, the third spectral bandwidth larger than 60 nm, the third color purity larger than 80%, wherein the green light has the second peak wave length between 510-550 nm, the second spectral bandwidth larger than 90 nm, the second purity larger than 60%, the blue peak wave length between 440-460 nm.

15. The lighting apparatus of claim 1, wherein in a third mode, the driver adjusts the third LED module to take a third light energy ratio between 10% to 57%, the second LED module to take a second light energy between 45% to 65%, and the first LED module to take a first energy ratio between 1% to 29%, wherein the first energy ratio, the second energy ratio and the third energy ratio are respectively energy levels over a total energy level of the first LED module, the second LED module and the third LED module.

16. The lighting apparatus of claim 15, wherein the red light has the third peak wave length between 625-635 nm, the third spectral bandwidth less than 60 nm, the third color purity larger than 80%, wherein the green light has the second peak wave length between 530-550 nm, the second spectral bandwidth larger than 90 nm, the second purity larger than 60%, the blue peak wave length between 450-470 nm.

17. The lighting apparatus of claim 1, wherein the driver sets energy ratio range limits respectively for the first LED module, the second LED module and the third LED module to keep a required color rendering index of the mixed light.

18. The lighting apparatus of claim 17, wherein two sets of the first LED module, the second LED module and the third LED module are disposed on a same light source plate, wherein the first LED modules of the two sets have different parameters, wherein the driver selects only one of the two sets of the first LED module, the second LED module and the third LED module to turn on for generating a mixed light of a required parameter while keeping the required color rendering index.

19. The lighting apparatus of claim 18, wherein a first set of the two sets has three first energy ratio ranges, wherein a second set of the two sets has three second energy ratio ranges, wherein the first energy ratio ranges and the second energy ratio ranges are partially overlapped to keep a required color rendering index range, if the driver determines that mixing the first set to achieve a required color temperature falls out of the first energy ratio ranges, the driver selects the second set to mix the desired color temperature.

20. The lighting apparatus of claim 19, wherein if the first set is less turned on than the second set, the driver turns on the first set when a predetermined condition is met.
